(19) United States
(12) Patent Application Publication
(10) Pub. No.: US 2024/0273342 A1
(43) Pub. Date: Aug. 15, 2024

(54) TRAINING DEVICE, TRAINING METHOD, AND TRAINING PROGRAM

(71) Applicant: NIPPON TELEGRAPH AND TELEPHONE CORPORATION, Tokyo (JP)

(72) Inventors: Naohiro TAWARA, Musashino-shi, Tokyo (JP); Atsunori OGAWA, Musashino-shi, Tokyo (JP); Hosana KAMIYAMA, Musashino-shi, Tokyo (JP); Yuki KITAGISHI, Musashino-shi, Tokyo (JP)

(73) Assignee: NIPPON TELEGRAPH AND TELEPHONE CORPORATION, Tokyo (JP)

(21) Appl. No.: 18/562,846

(22) PCT Filed: May 24, 2021
(86) PCT No.: PCT/JP2021/019615

§ 371 Date: Nov. 21, 2023

(51) Int. Cl. G06N 3/045; G06V 40/16; G10L 25/30

(52) U.S. Cl. CPC G06N 3/045; G06V 40/178; G10L 25/30

(57) ABSTRACT

A learning device collects a moving image with a voice from the Web, and extracts a series of face images and a voice of a person from the collected moving image. In addition, the learning device estimates an age of the person in the series of extracted face images by using a first NN (“neural network”) that estimates an age of a person in face images. Further, the learning device estimates an age of the person of the extracted voice by using a second NN that estimates an age of a person using a voice. Next, the learning device updates each parameter of the first NN or the second NN such that a difference between the age of the person estimated by the first NN and the age of the person estimated by the second NN is decreased. The learning device performs learning by repeatedly executing the processing.

### TECHNICAL FIELD

The present invention relates to a learning device, a learning method, and a learning program for learning an estimator that estimates an age of a person.

### BACKGROUND ART

An age estimation technique of estimating an age of a person from a voice or a face image is expected to be applied in a call center or a marketing field.

In recent years, in a voice field, as an age estimation technique using a neural network (NN), a method of directly estimating an age of a speaker from a voice waveform (refer to Non Patent Literature 1) is known. For example, Non Patent Literature 1 discloses a technique of estimating an age of a speaker by connecting an NN that converts a voice signal into a feature vector and an NN that estimates an age and simultaneously learning the NNs.

On the other hand, also in an image field, a method of directly estimating an age from a face image by using an NN (refer to Non Patent Literature 2 and Non Patent Literature 3) is known. For example, Non Patent Literatures 2 and 3 disclose a technique of estimating an age of a speaker by connecting an NN that converts a face image into a feature vector and an NN that estimates an age and simultaneously learning the NNs.

Further, a technique of estimating an age by simultaneously using face information and voice information (refer to Non Patent Literature 4) is also known. For example, Non Patent Literature 4 discloses a technique of estimating an age of a speaker with higher accuracy by connecting face information and voice information and estimating an age by multi-way regression as compared with a case where either information (modality) of the face information and the voice information is used.

### CITATION LIST

### Non Patent Literature

Non Patent Literature 1: P. Ghahremani, et al. “End-to-End Deep Neural Network Age Estimation”, Proc. Interspeech, pp. 277-281, 2018. [Retrieved on May 11, 2021], the Internet <https://www.isca-speech.org/archive/Interspeech_2018/pdfs/2015.pdf>
Non Patent Literature 2: A. Fariza, et al. “Age Estimation System Using Deep Residual Network Classification Method”, in Proc. IES, 2019, pp. 607-611, [Retrieved on May 11, 2021], the Internet <https://ieeexplore.ieee.org/stamp/stamp.jsp?tp=&arnumber=8 901521>
Non Patent Literature 3: R. Rothe, et al. “Deep Expectation of Real and Apparent Age from a Single Image Without Facial Landmarks”, in International Journal of Computer Vision, vol. 126, no. 2-4, pp. 144-157, Springer, 2018.
Non Patent Literature 4: E. Pantraki, C. Kotropoulos, “Multi-Way Regression for Age Prediction Exploiting Speech and Face Image Information”, in Proc. In EUSIPCO, 2017, pp. 2196-2200., [Retrieved on May 11, 2021], the Internet <https://www.eurasip.org/Proceedings/Eusipco/Eusipco2017/papers/1570348322.pdf>

### SUMMARY OF INVENTION

### Technical Problem

Here, the face information and the voice information of the speaker are affected by aging of the speaker. On the other hand, there are individual differences in aging. For this reason, in order to configure an NN that robustly operates even for an unknown person, a large amount of training data is required. In particular, in a case of using a large-scale NN that requires learning of a large number of parameters, when a sufficient amount of learning data is not provided, there is a problem that estimation accuracy of an age of an unknown person is significantly lowered due to over-learning.

In order to solve the problem, for example, in the technique described in Non Patent Literature 3, a large number of face images of entertainers and the like and age information of the entertainers are collected from the Web, and are used for learning of the NN. In addition, in the technique described in Non Patent Literature 1, learning of the NN is performed using an English voice corpus published for speaker estimation of approximately 1000 speakers.

However, as compared with the face data, the voice data includes a smaller number of available data. In addition, most of available voice corpuses are limited to narrowband English voices. For this reason, in a case where the NN learned by the voice corpus is applied to wideband voices and Japanese voices as it is, there is a problem that estimation accuracy of an age is decreased. As a result, it is known that age estimation by voice information is more difficult than age estimation by face information.

Therefore, an object of the present invention is to solve the problems described above and to obtain an estimator that accurately estimates an age of a person without using a large amount of learning data.

### Solution to Problem

In order to solve the problems described above, according to the present invention, there is provided a learning device including: a moving image collection unit that collects a moving image with a voice from the Web; a data extraction unit that extracts a series of face images of a person from the collected moving image and extracts a voice of the person in the series of extracted face images; a first NN that estimates an age of the person in the face images using the series of extracted face images; a second NN that estimates an age of the person using the extracted voice of the person; an update unit that updates each parameter of the first NN or the second NN such that a difference between the age of the person estimated by the first NN and the age of the person estimated by the second NN is decreased; and a control processing unit that repeatedly executes processing by the moving image collection unit, the data extraction unit, the first NN, the second NN, and the update unit until a predetermined condition is satisfied.

### Advantageous Effects of Invention

According to the present invention, it is possible to obtain an estimator that accurately estimates an age of a person without using a large amount of learning data.

### BRIEF DESCRIPTION OF DRAWINGS

FIG. 1 is a diagram illustrating a configuration example of a learning device.

FIG. 2 is a diagram illustrating an example of a first NN in FIG. 1.

FIG. 3 is a diagram illustrating an example of a second NN in FIG. 1.

FIG. 4 is a flowchart illustrating an example of a processing procedure of the learning device in FIG. 1.

FIG. 5 is a diagram for explaining an estimation device that performs age estimation using the second NN learned by the learning device.

FIG. 6 is a diagram illustrating an example of a computer that executes a learning program.

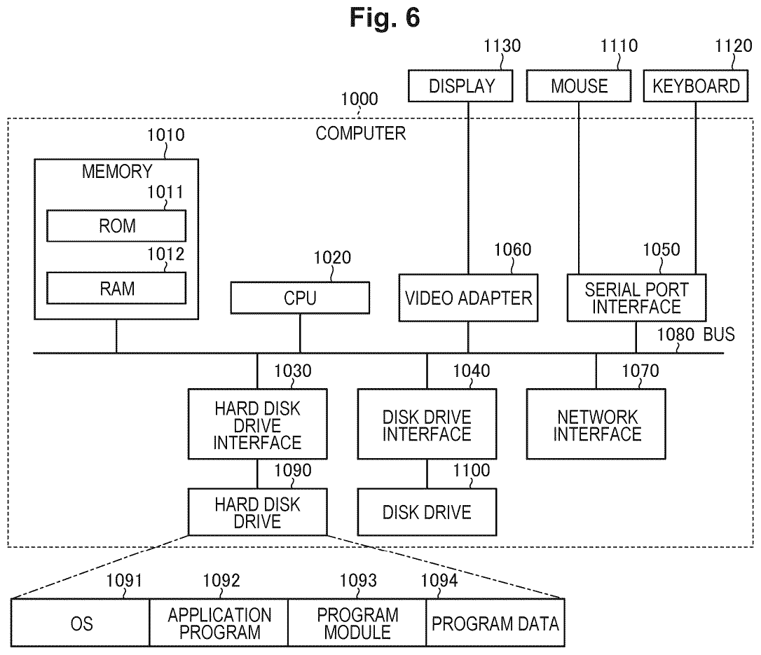

### DESCRIPTION OF EMBODIMENTS

Hereinafter, forms (embodiments) for carrying out the present invention will be described with reference to the drawings. The present invention is not limited to the embodiments.

[Outline]

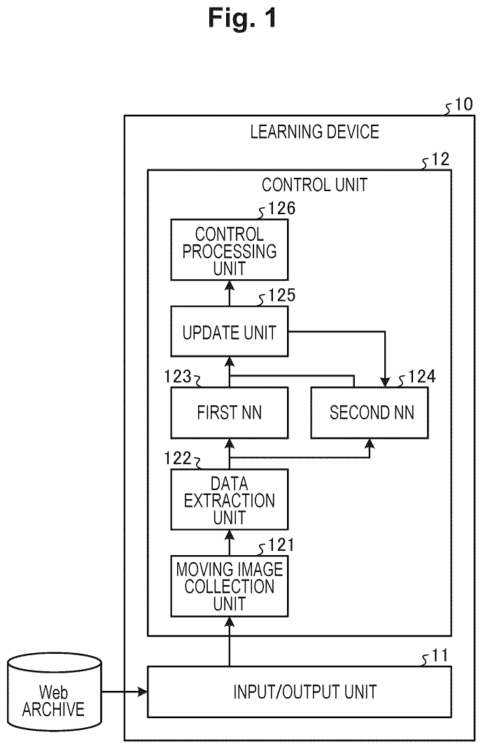

An outline of a learning device 10 according to the present embodiment will be described with reference to FIG. 1. The learning device 10 includes an NN (first NN 123) that estimates an age of a person using face information and an NN (second NN 124) that estimates the age of the person using voice information. In a case where a moving image with a voice of a person is collected from a Web archive or the like, the learning device 10 estimates an age of the person by the first NN 123 using face information of the collected moving image. In addition, the learning device 10 estimates an age of the person by the second NN 124 using voice information of the moving image. Further, the learning device 10 updates each parameter of the second NN 124, for example, such that an estimation result of the age of the person by the second NN 124 approaches an estimation result of the age of the person by the first NN 123.

### Configuration Example

Next, a configuration example of the learning device 10 will be described with reference to FIG. 1. The learning device 10 includes an input/output unit 11 and a control unit 12. The input/output unit 11 controls input/output of various data. The input/output unit 11 receives an input of a moving image with a voice of a person from, for example, a Web archive.

The control unit 12 controls the entire learning device 10. For example, the control unit 12 includes a moving image collection unit 121, a data extraction unit 122, a first NN 123, a second NN 124, an update unit 125, and a control processing unit 126.

The moving image collection unit 121 collects a moving image with a voice that is archived on the Web. For example, the moving image collection unit 121 collects an interview moving image or the like of a person from the Web archive.

The data extraction unit 122 extracts a series of face images of the person and a voice of the person from the moving image collected by the moving image collection unit 121.

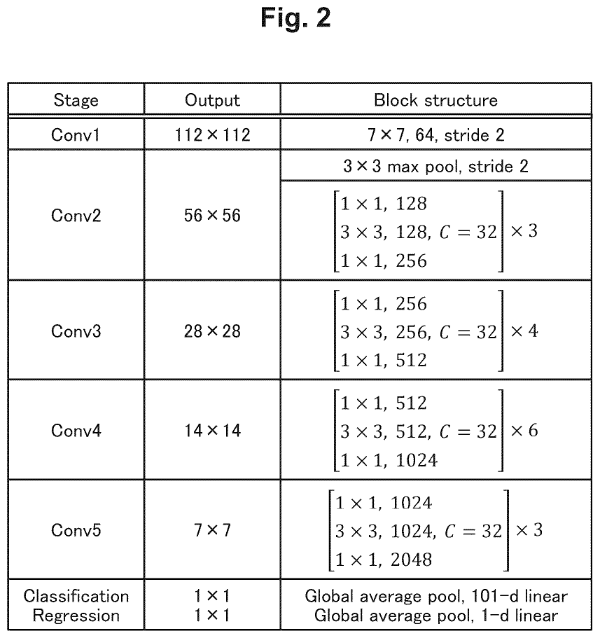

The first NN 123 is an NN that estimates an age of the person using a series of face images of the person extracted by the data extraction unit 122. The first NN 123 is implemented, for example, by connecting an NN for estimating an age to an NN for converting a face image into a feature vector by using a technique described in Non Patent Literature 2. The first NN 123 is implemented by, for example, an NN having a structure as illustrated in FIG. 2.

As an example, the first NN 123 is implemented by a convolutional NN including a plurality of residual blocks in which squeeze-and-excitation is adopted. The NN is, for example, a class classifier obtained by replacing a final layer of a model learned in advance using ImageNet with two fully connected layers each of which outputs a posterior probability and an age value with respect to an age 101 class and performing fine tuning of the entire model based on a multi-task criterion including a softmax cross entropy and a square error minimization criterion.

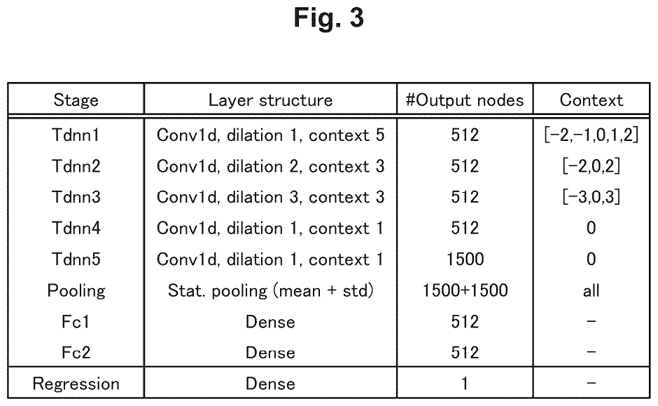

The second NN 124 is an NN that estimates an age of the person using a voice of the person extracted by the data extraction unit 122. The second NN 124 is implemented, for example, by connecting an NN for estimating an age to an NN for converting a voice signal into a feature vector by using a technique described in Non Patent Literature 1. The second NN 124 is implemented by, for example, an NN having a structure as illustrated in FIG. 3.

As an example, the second NN 124 is an NN that estimates an age based on an x-vector. Note that, as an extractor of the x-vector, for example, an extractor that is learned by removing SRE 10 from Kaldi SRE 16 recipe is used. The second NN 124 estimates an age by applying, to the x-vector extracted by the extractor, an NN including two 512-dimensional fully connected layers and one-dimensional fully connected layers which output an age value.

The update unit 125 updates each parameter of the second NN 124 such that a difference between the age of the person estimated by the first NN 123 and the age of the person estimated by the second NN 124 is decreased.

For example, assuming that y₁ is an estimated value of the age of the person by the first NN 123, that y₂ is an estimated value of the age of the person by the second NN 124, that L is a loss between y₁ and y₂, and that 0 is a parameter to be updated, the update unit 125 updates the parameter (each parameter of the second NN 124) by the following Mathematical Expression (1).

$$\begin{matrix}[ Mathematical Expression 1 ] & \\ \begin{matrix}L = {( {y}_{1} - {y}_{2} )}^{2} \\ θ ← θ - µ ( \frac{ϑ L}{ϑθ} )\end{matrix} & ( 1 )\end{matrix}$$

Note that μ in Mathematical Expression (1) is a preset learning weight and is a positive constant. The update unit 125 updates the parameter of the second NN 124 as described above, and thus the parameter of the second NN 124 is updated so as to imitate the first NN 123.

The control processing unit 126 repeatedly executes processing by the moving image collection unit 121, the data extraction unit 122, the first NN 123, the second NN 124, and the update unit 125 until a predetermined condition is satisfied. That is, the control processing unit 126 causes the update unit 125 to repeatedly update the parameter of the second NN 124 until a predetermined condition is satisfied. The predetermined condition is, for example, a condition that the learning of the second NN 124 is sufficiently performed, such as a condition that the number of repetitions reaches a predetermined number, or a condition that an update amount of the parameter of the second NN 124 is smaller than a predetermined threshold value.

According to the learning device 10, it is possible to obtain the estimator (second NN 124) that accurately estimates the age of the person from the voice information without using a large amount of learning data.

### [Example of Processing Procedure]

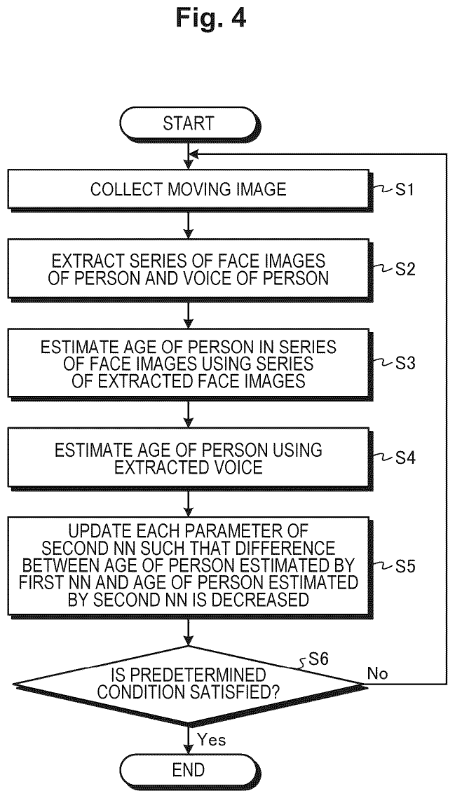

Next, an example of a processing procedure of the learning device 10 will be described with reference to FIG. 4. First, the moving image collection unit 121 of the learning device 10 collects, for example, a moving image with a voice that is archived on the Web (S1). Next, the data extraction unit 122 extracts a series of face images of the person and a voice of the person from the moving image collected by the moving image collection unit 121 (S2).

After S2, the first NN 123 estimates an age of the person in the series of face images using the series of face images extracted in S2 (S3). In addition, the second NN 124 estimates the age of the person using the voice extracted in S2 (S4). Further, the update unit 125 updates each parameter of the second NN 124 such that a difference between the age of the person estimated in S3 by the first NN 123 and the age of the person estimated by the second NN 124 is decreased (S5).

After S5, in a case where it is determined that the predetermined condition is satisfied, for example, in a case where the number of times of processing of S1 to S5 reaches the predetermined number of times, or in a case where the update amount of the parameter of the second NN 124 is smaller than the predetermined threshold value (Yes in S6), the control processing unit 126 ends the processing. On the other hand, in a case where it is determined that the predetermined condition is not satisfied, for example, in a case where the number of times of processing of S1 to S5 does not reach the predetermined number of times, or in a case where the update amount of the parameter of the second NN 124 is equal to or larger than the predetermined threshold value (No in S6), the control processing unit 126 returns the processing to S1, and executes again the processing by the moving image collection unit 121, the data extraction unit 122, the first NN 123, the second NN 124, and the update unit 125.

According to the learning device 10, it is possible to obtain the estimator (second NN 124) that accurately estimates the age of the person from the voice information without using a large amount of learning data.

Note that the learning device 10 is similar to the technique disclosed in Non Patent Literature 4 in that both a voice and a face image are used. On the other hand, the learning device 10 is different from the technique disclosed in Non Patent Literature 4 in the following points.

Firstly, the technique disclosed in Non Patent Literature 4 performs learning of an age estimator by connecting voice information and face information. On the other hand, the learning device 10 is different in that the second NN 124 which performs age estimation of the person from the voice is learned such that the second NN 124 imitates the first NN 123 which performs age estimation of the person from the face image.

Further, the technique disclosed in Non Patent Literature 4 can be applied only in a case where age labels are assigned to all data. On the other hand, the learning device 10 automatically assigns age labels to a series of face images in a moving image by the first NN 123. Therefore, there is an advantage that the learning device 10 can perform learning even from data to which an age label is not assigned.

Secondly, in the technique disclosed in Non Patent Literature 4, multi-way regression is used as an age estimator. As a result, it is necessary to extract intermediate feature amounts. On the other hand, the learning device 10 can directly estimate an age of the person with high accuracy from the voice and the face image by using the NN as an age estimator.

### Other Embodiments

Note that the roles of the first NN 123 and the second NN 124 of the learning device 10 can be exchanged. For example, in a case where the second NN 124 has higher age estimation accuracy than the first NN 123, the learning device 10 may update each parameter of the first NN 123 such that the first NN 123 imitates the second NN 124. That is, the learning device 10 may update each parameter of the first NN 123 such that an error between the age of the person estimated from the face image by the first NN 123 and the age of the person estimated from the voice by the second NN 124 is decreased.

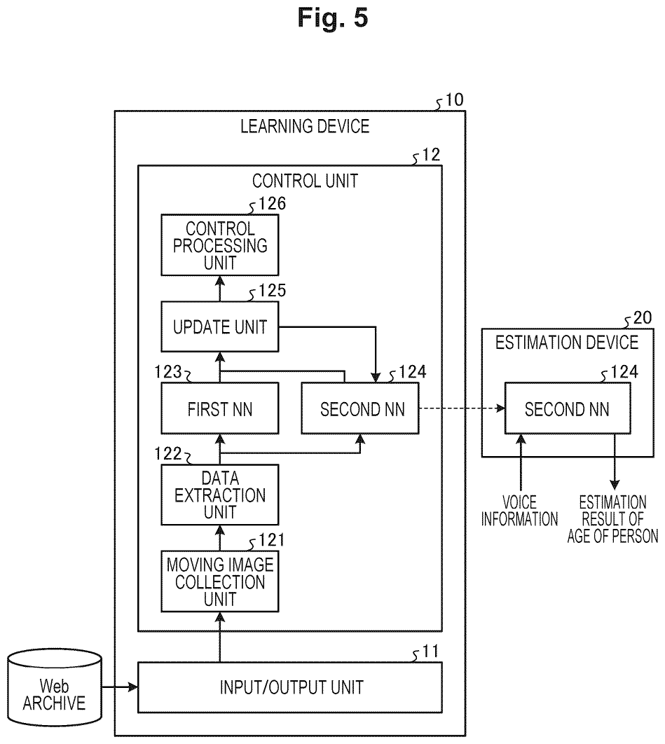

In addition, the learning device 10 may estimate the age of the person from the input voice (voice information) using the learned second NN 124 after learning of the second NN 124. Further, the second NN 124 learned by the learning device 10 may be used by an external device. For example, as illustrated in FIG. 5, an estimation device 20 provided outside the learning device 10 may estimate the age of the person from the voice information using the second NN 124 learned by the learning device 10.

### [Experiment Results]

Hereinafter, experiment results of the second NN 124 learned using the learning device 10 will be described. Here, the learning device 10 performs learning of the second NN 124 (voice age estimator) by using approximately 150,000 moving images of 4,479 speakers collected from YouTube (registered trademark) as learning data. Thereafter, the learning device 10 performs age estimation of the speakers on 16,000 moving images of 497 speakers similarly collected from YouTube, by using the second NN 124. As a result, an absolute error between a correct age value and an estimation result of the age of the speaker by the second NN 124 was 8.59 years. In addition, a correlation coefficient between the correct age value and the estimation result of the age of the speaker was 0.70.

On the other hand, for reference, in a case where the second NN 124 is learned using a true age value assigned to the learning data, an absolute error from the estimation result of the age of the speaker by the second NN 124 was 7.43 years, and the correlation coefficient was 0.74. From this, it is confirmed that a framework for learning the second NN 124 (voice age estimator) such that the second NN 124 imitates the first NN 123 (face age estimator) as in the learning device 10 effectively functions.

### [System Configuration and Others]

In addition, each component of each unit illustrated in the drawings is functionally conceptual, and does not necessarily need to be physically configured as illustrated in the drawings. That is, a specific form of distribution and integration of each device is not limited to the illustrated form. All or some of the components may be functionally or physically distributed and integrated in an arbitrary unit according to various loads, usage conditions, and the like. Further, all or any part of each processing function performed in each device can be implemented by a CPU and a program executed by the CPU, or can be implemented as hardware by wired logic.

In addition, in the processing described in the embodiment, all or a part of processing described as being automatically performed may be manually performed, or all or a part of processing described as being manually performed may be automatically performed by a known method. In addition, the processing procedure, the control procedure, the specific names, and the information including various types of data and parameters illustrated in the document and the drawings can be freely changed unless otherwise specified.

### [Program]

The learning device 10 can be implemented by installing a program in a desired computer as package software or online software. For example, an information processing device can be caused to function as the learning device 10 by causing the information processing device to execute the program. The information processing device mentioned here includes a desktop or a laptop personal computer. In addition, the information processing device also includes mobile communication terminals such as a smartphone, a mobile phone, and a personal handyphone system (PHS) and terminals such as a personal digital assistant (PDA).

In addition, in a case where a terminal device used by a user is implemented as a client, the learning device 10 can also be implemented as a server device that provides a service related to the processing to the client. In this case, the server device may be implemented as a web server or may be implemented as a cloud that provides a service related to the processing by outsourcing.

FIG. 8 is a diagram illustrating an example of a computer that executes a learning program. A computer 1000 includes, for example, a memory 1010 and a CPU 1020. In addition, the computer 1000 also includes a hard disk drive interface 1030, a disk drive interface 1040, a serial port interface 1050, a video adapter 1060, and a network interface 1070. These units are connected to each other by a bus 1080.

The memory 1010 includes a read only memory (ROM) 1011 and a random access memory (RAM) 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disc is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, a program that defines each processing to be executed by the learning device 10 is implemented as the program module 1093 in which codes executable by the computer are described. The program module 1093 is stored in, for example, the hard disk drive 1090. For example, the program module 1093 for executing processing similar to the functional configuration in the learning device 10 is stored in the hard disk drive 1090. Note that the hard disk drive 1090 may be replaced with a solid state drive (SSD).

In addition, data used in the processing of the above-described embodiment is stored, for example, in the memory 1010 or the hard disk drive 1090 as the program data 1094. In addition, the CPU 1020 reads the program module 1093 and the program data 1094 stored in the memory 1010 and the hard disk drive 1090 into the RAM 1012 as necessary and executes the program module 1093.

Note that the program module 1093 and the program data 1094 are not limited to being stored in the hard disk drive 1090 and may be stored in, for example, a removable storage medium and read by the CPU 1020 via the disk drive 1100 or the like. Alternatively, the program module 1093 and the program data 1094 may be stored in another computer connected via a network (a local area network (LAN), a wide area network (WAN), or the like). In addition, the program module 1093 and the program data 1094 may be read by the CPU 1020 from another computer via the network interface 1070.

### REFERENCE SIGNS LIST

10 Learning device
20 Estimation device
11 Input/output unit
12 Control unit
121 Moving image collection unit
122 Data extraction unit
123 First NN
124 Second NN
125 Update unit
126 Control processing unit

1. A learning device comprising:
moving image collection circuitry that collects a moving image with a voice from the Web;
data extraction circuitry that extracts a series of face images of a person from the collected moving image and extracts a voice of the person in the series of extracted face images;
a first NN (“neural network”) that estimates an age of the person in the face images using the series of extracted face images;
a second NN (“neural network”) that estimates an age of the person using the extracted voice of the person;
update circuitry that updates each parameter of the first NN or the second NN such that a difference between the age of the person estimated by the first NN and the age of the person estimated by the second NN is decreased; and
control processing circuitry that repeatedly executes processing by the moving image collection circuitry, the data extraction circuitry, the first NN, the second NN, and the update circuitry until a predetermined condition is satisfied.

2. The learning device according to claim 1, wherein the predetermined condition is:
a condition that the number of repetitions of the processing by the moving image collection circuitry, the data extraction circuitry, the first NN, the second NN, and the update circuitry reaches a predetermined number, or
a condition that an update amount of the parameter of the first NN or the second NN made by the update circuitry is smaller than a predetermined threshold value.

3. The learning device according to claim 1, wherein:
the update circuitry updates each parameter of the second NN such that a difference between the age of the person estimated by the first NN and the age of the person estimated by the second NN is decreased.

4. The learning device according to claim 1, wherein:
the update circuitry updates each parameter of the first NN such that a difference between the age of the person estimated by the first NN and the age of the person estimated by the second NN is decreased.

5. A learning method, comprising:
collecting a moving image with a voice from the Web;
extracting a series of face images of a person from the collected moving image and extracting a voice of the person in the series of extracted face images;
estimating an age of the person in the face images using the series of extracted face images by a first NN (“neural network”) that estimates, using face images, an age of a person in the face images;
estimating an age of the person using the extracted voice of the person by a second NN (“neural network”) that estimates, using a voice of a person, an age of the person;
updating each parameter of the first NN or the second NN such that a difference between the age of the person estimated by the first NN and the age of the person estimated by the second NN is decreased; and
repeatedly executing the collecting, the extracting, both of the estimating, and the updating until a predetermined condition is satisfied.

6. A non-transitory computer readable medium storing a learning program causing a computer to function as the learning device according to claim 1.

7. A non-transitory computer readable medium storing a learning program causing a computer to perform the learning method of claim 5.
